(19) United States
(12) Patent Application Publication
(10) Pub. No.: US 2026/0106354 A1
(43) Pub. Date: Apr. 16, 2026

(54) Assembly With Battery Cell, Intercell Connector and Conducting Element

(71) Applicant: Bayerische Motoren Werke Aktiengesellschaft, Muenchen (DE)

(72) Inventors: Alexander GANS, Puchheim (DE); Klaus LOEFFLER, Muenchen (DE); Sascha ZIMMERMANN, Muenchen (DE)

(21) Appl. No.: 19/357,218

(22) Filed: Oct. 14, 2025

(30) Foreign Application Priority Data
Oct. 16, 2024 (DE) 10 2024 129 993.2

(51) Int. Cl. H01M 50/583; H01M 50/107; H01M 50/119; H01M 50/152; H01M 50/179; H01M 50/213; H01M 50/249; H01M 50/502; H01M 50/588

(52) U.S. Cl. CPC H01M 50/583; H01M 50/107; H01M 50/119; H01M 50/152; H01M 50/179; H01M 50/213; H01M 50/249; H01M 50/502; H01M 50/588; H01M 2200/103

(57) ABSTRACT

An assembly for a traction battery of a motor vehicle, includes: a battery cell having a metallic cell housing, a first cell pole and a second cell pole which assumes a potential of the cell housing; an intercell connector, which is electrically connected to the first cell pole to form a current path between the battery cell and at least one further battery cell of the traction battery, and which has a fuse for interrupting the current path in response to flux of a tripping current via the intercell connector; and at least one electrically conductive conducting element, which is electrically and mechanically connected to the intercell connector and/or to the first cell pole, and which is designed, in the event of a fault current flux via the intercell connector which lies below the tripping current and which results in a melting and subsidence of the first cell pole and/or of the intercell connector in the direction of the cell housing, to contact-connect the cell housing and thus short-circuit the cell poles, for the provision of the tripping current.

### CROSS REFERENCE TO RELATED APPLICATION

This application claims priority under 35 U.S.C. § 119 from German Patent Application No. 10 2024 116 269.4, filed Jun. 11, 2024, the entire disclosure of which is herein expressly incorporated by reference.

### BACKGROUND AND SUMMARY

The invention relates to an assembly for a traction battery of a motor vehicle. The assembly comprises a battery cell having a metallic cell housing, a first cell pole and a second cell pole which assumes a potential of the cell housing. The assembly moreover comprises an intercell connector, which is electrically connected to the first cell pole to form a current path between the battery cell and at least one further battery cell of the traction battery, and which comprises a fuse for interrupting the current path in response to the flux of a tripping current via the intercell connector. The invention also relates to a traction battery.

The object of focus in the present case are traction batteries for electrified motor vehicles. Traction batteries customarily comprise a multiplicity of battery cells which, by means of intercell connectors, are correspondingly interconnected in a predefined interconnection layout. Connecting elements can incorporate integrated fuses, for example fusible links, which are tripped in the event of a fault and are intended to interrupt a current path between the battery cells. For example, DE 10 2022 124 457 A1 discloses a fusible link which is configured in the form of a cross-sectional taper in the intercell connector, and which is intended to trip in the event of the flux of a fault current via the intercell connector.

In order to trip, fusible links customarily require a fault current in the form of a tripping current, the current intensity of which is higher than the current intensity of an operating current which is carried by the intercell connector, and which thus generates a heating effect which is sufficient, not only for melting the material of the intercell connector, but also for the generation of further effects, such as a movement of the molten material, a further heat-up of the liquid molten material, vaporization of the molten material, etc.. These further effects ultimately result in the interruption of the intercell connector. Under specific fault conditions, however, the fault current is not sufficiently high to generate effects over and above the melting of the material. It can thus occur that the fault current continues to flow via the only insufficiently melted intercell connector, as a result of which further heat is released into the electrical energy store. This can result in unwanted consequential damage.

The object of the present invention is to enable a simple, secure and reliable interruption of a current path between two battery cells of a traction battery, in the event of a fault.

According to the invention, this object is fulfilled by an assembly and by a traction battery having the features of the respective independent patent claims. Advantageous embodiments of the invention are the subject matter of the dependent patent claims, the description and the figures.

An assembly according to the invention for the traction battery of a motor vehicle comprises a battery cell having a metallic cell housing, a first cell pole and a second cell pole which assumes a potential of the cell housing. The assembly moreover comprises an intercell connector, which is electrically connected to the first cell pole to form a current path between the battery cell and at least one further battery cell of the traction battery, and which comprises a fuse for interrupting the current path in response to the flux of a tripping current via the intercell connector. The assembly moreover comprises at least one electrically conductive conducting element, which is electrically and mechanically connected to the intercell connector and/or to the first cell pole, and which is designed, in the event of a fault current flux via the intercell connector which lies below the tripping current and which results in a melting and subsidence of the first cell pole and/or of the intercell connector in the direction of the cell housing, to contact-connect the cell housing and thus short-circuit the cell poles, for the provision of the tripping current.

A traction battery according to the invention for a motor vehicle comprises a multiplicity of assemblies according to the invention, wherein the battery cells form a cell assembly and the intercell connectors form a cell contact system for the interconnection of battery cells according to a predetermined interconnection layout. In particular, the traction battery is a high-voltage energy store, and is designed to supply electrical energy to at least one electrical drive machine of the motor vehicle.

The battery cell of the assembly particularly comprises a metallic cell housing, in the interior of which a galvanic element of the battery cell is arranged. Electrodes of the galvanic element are connected to cell poles or cell terminals, the contact points of which are located outside the interior space, and by means of which the battery cell can be inter-connected in series and/or in parallel with other battery cells in the cell assembly. The battery cell is preferably configured as a round cell with a cylindrical metallic housing, wherein the first cell pole, particularly the positive pole, is embodied by a contact element which is electrically insulated from the cell housing, and the second cell pole, particularly the negative pole, is embodied by the cell housing itself. The cell housing and the second cell pole thus assume the same electrical potential. The cell housing can be formed, for example, of steel. The contact element can be formed, for example, of aluminum. An insulating element, for example in the form of a plastic sealing ring, is customarily arranged between the cylindrical contact element and the cell housing. The plastic sealing ring can radially enclose the contact element, such that the plastic sealing ring is radially arranged between the contact element and one edge of the feed-through opening, and axially arranged between surfaces of the housing cover and the contact element.

The intercell connector, which can be configured for the serial and/or parallel interconnection of multiple battery cells, is particularly comprised of a metallic material, in particular aluminum, which is customarily enclosed in a passivation layer. The passivation layer, in particular, is an oxide layer, which can form spontaneously, for example in the presence of oxygen or in response to the fault-related generation of heat, or which can be generated deliberately, for example by passivation, anodization or chromate coating of the surface of the metallic material. The passivation layer thus assumes a higher melting point than the metallic material, and is highly thermally robust as a result.

The intercell connector is configured, for example, as a flat metallic part or sheet metal part and, in relation to the width and length thereof, assumes a significantly smaller material thickness. For example, the intercell connector can be formed from sheet metal by a separation process. A separation process of this type can be, for example, stamping or laser cutting. By means of the separation process, the intercell connector can be produced as a one-piece monobloc component having a predefined shape, in particular a predefined outline. By a subsequent bending process, moreover, a vertical profile can be incorporated in the intercell connector. For example, the vertical profile can comprise strain-or vibration-absorbing projections or convexities. The cell contact system can comprise differently shaped intercell connectors, depending upon the number of battery cells, and thus the number of cell poles which are intended to be contact-connected by the respective intercell connector, and which type of interconnection of battery cells, for example a parallel connection and/or a serial connection, is to be provided. Intercell connectors can be configured, for example, with an I-shape or L-shape, and can respectively contact-connect one cell pole of two battery cells, or can be configured with a comb structure of finger structure, and can thus respectively contact-connect one cell pole of at least three battery cells.

The intercell connector comprises contact regions, which are electrically and mechanically connected to the respective cell pole, for example by welding. Contact regions can be formed, for example, by terminal sections of the intercell connector. In particular, the intercell connector comprises at least one first contact region for contact-connecting with the first cell pole of at least one battery cell, and at least one second contact region for contact-connecting with the second cell pole of at least one further battery cell. The first contact regions can thus assume a first shape, and the second contact regions can assume a second shape, which differs from the first shape, wherein the respective shape of the contact regions is adapted to the geometrical shape of the cell pole. In the case of intercell connectors which connect round cells, the first, positive pole-side contact regions can be disk-shaped, for example circular disk-shaped, for the engagement thereof with the circular surface of the cylindrical contact element, and the second, negative pole-side contact regions can be crescent-shaped or annular segment shaped, for the engagement thereof with the annular surface of the housing cover of the cell housing which forms the negative pole.

The intercell connector moreover comprises a fuse, in particular a fusible link which, in particular, is configured by a cross-sectional taper in the intercell connector. In the event of a fault, this integrated fuse is intended to trip and to interrupt current conduction via the intercell connector, and thus the current flux between battery cells which are connected by means of the intercell connector. The fault can be a defect in a battery cell, for example an internal cell short-circuit, which can result in a thermal runaway of the battery cell and an associated heat-up of the cell housing of the battery cell. In the event of a fault, it is intended that the material of the intercell connector, in response to the heating effect generated by the fault in the region of the fusible link, should substantially melt, and be removed by further fault-related effects, such that the intercell connector is severed. It can occur, however, that the heating effect of the fault, and the associated input of heat to the fusible link, are not sufficient to completely sever the intercell connector. This can occur, for example, in the event that the fault current is not an overcurrent which generates an abrupt melting of the fusible link, but the current intensity thereof lies within the region of the operating current, such that the material of the intercell connector undergoes only a slow and/or insufficient heat-up. A fault current of this type which lies within the region of the operating current can be caused, for example by an unwanted electrical connection between the cell poles, or a “mid-ohmic” secondary short-circuit between the cell poles. A secondary short-circuit of this type can proceed, for example, from a degradation of the insulating element between the cell poles. The insulating element is thus destroyed, and the melting first cell pole, together with the likewise melting intercell connector, which is electrically connected to the first cell pole, subsides in the direction of the housing cover. An electrical connection is thus established between the first cell pole or the intercell connector and the housing cover, such that an electrical connection is formed between the cell poles. Particularly in the event that the temperature of intercell connector material, as a result of a fault-related thermal input, exceeds the melting point of the material, but not the melting point of the passivation layer, a current flux is maintained via molten material which is enclosed in the passivation layer, which can result in a further heat-up of the battery cells, and in further potential short-circuits within the traction battery.

In order to enable the reliable interruption of the current flux, even in the event of such a fault, at least one additional component is provided in the form of the electrically conductive conducting element on the intercell connector and/or on the first cell pole which, excepting a fault, assumes no contact with the cell housing and, in the event of a fault, engages in contact with the cell housing. In this contact-connected state, the conducting element is designed to increase the current intensity of the fault current flowing via the intercell connector. To this end, the conducting element is fastened to the intercell connector or to the first cell pole, and is rigidly bonded thereto, such that the conducting element, excepting a fault, is arranged with a clearance to the cell housing and, in the event of a fault, subsides in combination with the intercell connector or the first cell pole, and thus engages in contact with the cell housing. An electrical connection is also established between the first and second cell pole. This electrical connection, which is deliberately introduced by means of the conducting element, thus assumes a higher electrical conductivity than the electrical connection between the cell poles which is introduced by the subsidence of the first cell pole. In particular, by means of the subsided conducting element, in parallel with the mid-ohmic short-circuit, a low-ohmic short-circuit between the first and second cell pole is actively introduced or implemented. As a result, by way of the tripping current, a short-circuit current is provided and routed via the intercell connector, which short-circuit current reliably trips the fuse, and thus interrupts the current path.

By means of the conducting element, in a simple and reliable manner, a tripping of the fuse can be provided, and an isolating capability of the fuse in the low short-current range can be improved.

The conducting element preferably comprises a material which differs from a material of the first cell pole and of the intercell connector, such that the electrical connection between the cell poles which is established by means of the conducting element in the event of a fault assumes a higher electrical conductivity than the electrical connection between the cell poles which is established in the event of a fault by the subsidence of the first cell pole. For example, the material of the conducting element assumes a higher melting point than the material of the first cell pole and of the intercell connector. In particular, the material of the conducting element is not fusible. In other words, fault-related heat generation is not sufficient to exceed the melting point of the material of the conducting element. It can thus be prevented that the material of the conducting element, upon the melting of the intercell connector and of the cell pole, is also melted. For example, the material of the conducting element is steel, whereas the material of the first cell pole and of the intercell connector is aluminum. Thus, in particular, the conducting element comprises the same material as the cell housing such that, upon the contact thereof with the cell housing, a particularly low contact resistance between the cell housing and the conducting element, and thus a particularly low-ohmic electrical connection between the cell poles, is generated. The conducting element can also comprise tin and/or copper. These materials also assume a particularly high electrical conductivity. The conducting element can be configured, for example, with a plate-type or strip-shaped design and, on the grounds of its large surface area, assumes a high current-carrying capacity. The at least one conducting element can thus be configured as a simple and cost-effective metal component, and fastened to the first cell pole or to the intercell connector, for example by welding.

According to one configuration of the invention, the at least one conducting element is fastened in an overlapping arrangement to the first cell pole on the upper side of the intercell connector, and projects beyond one edge of the first cell pole, such that it partially overlaps with the housing cover. The conducting element, in the first contact region of the intercell connector, is thus arranged on the surface thereof, such that an axially extending layer stack comprised of the first cell pole, the intercell connector and the at least one conducting element is formed. Transversely to the layer stack, the at least one conducting element extends beyond the edge of the first cell pole to the extent that, excepting a fault, the conducting element is arranged with an axial clearance to, but in an overlapping arrangement with the housing cover. In the event of a fault, the conducting element, which is rigidly bonded to the intercell connector, in combination with the first cell pole, moves downwards in the direction of the housing cover. Immediately the conducting element contacts the housing cover, the low-ohmic electrical connection between the cell poles is formed.

It can also be provided that the at least one conducting element is arranged on an underside of the intercell connector. Excepting a fault, the at least one conducting element is arranged with a clearance to the housing cover. In response to the fault-related melting of the intercell connector and/or the subsidence of the first cell pole, the conducting element also subsides, and thus establishes the low-ohmic electrical connection between the intercell connector and the housing cover, and between the cell poles. For example, the conducting element can be arranged in the region of the fuse. For example, the intercell connector can be arranged in the region of the fuse, which is configured by the at least one cross-sectional taper, which taper comprises the vibration-absorbing convexity, wherein the at least one conducting element, at the underside, is arranged in the convexity. In the event of the fault-related melting of the intercell connector, this convexity subsides, wherein the conducting element engages with the housing cover as a result, and is thus contact-connected thereto.

Embodiments presented with respect to the assembly according to the invention, and the advantages thereof, apply in a corresponding manner to the traction battery according to the invention.

Further features of the invention proceed from the claims, the figures and the description of the figures. Features and combinations of features specified in the preceding description, together with features and combinations of features specified hereinafter in the description of the figures and/or represented in the figures alone, are not only applicable in the respectively indicated combination, but also in other combinations, or in isolation.

Other objects, advantages and novel features of the present invention will become apparent from the following detailed description of one or more preferred embodiments when considered in conjunction with the accompanying drawings.

### BRIEF DESCRIPTION OF THE DRAWINGS

FIGS. 1A, 1B show a schematic representation of a first configuration of an assembly for a traction battery of a motor vehicle; and

FIGS. 2A, 2B show a schematic representation of a second configuration of an assembly for a traction battery of a motor vehicle.

In the figures, identical and functionally equivalent elements are identified by the same reference symbols.

### DETAILED DESCRIPTION OF THE DRAWINGS

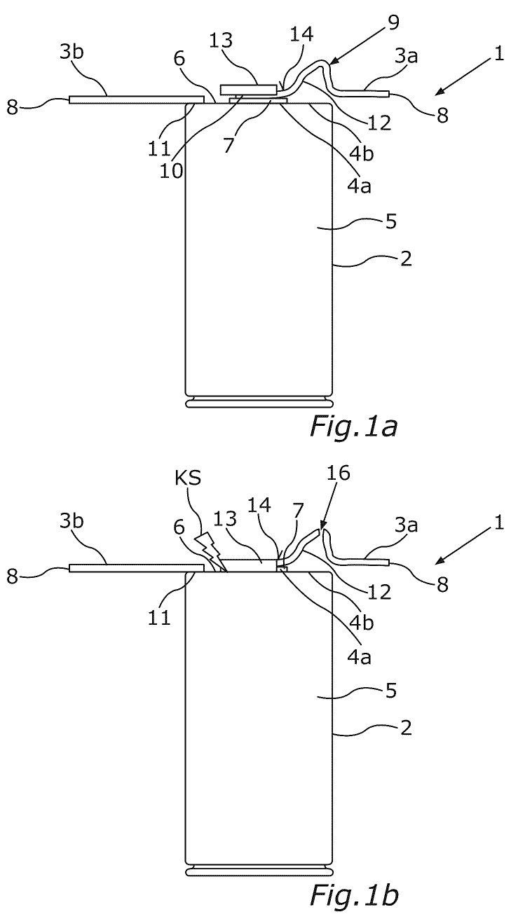

FIG. 1A and FIG. 1B show an assembly 1 for a traction battery of an electrically powered motor vehicle, for example a hybrid vehicle or an electric vehicle. The assembly 1 comprises a battery cell 2 and two intercell connectors 3a, 3b for electrically connecting the battery cell 2 to further battery cells of the traction battery. The battery cell 2 comprises a first cell pole 4a in the form of a positive pole, which is electrically and mechanically connected to a positive pole-side contact region 10 of the intercell connector 3a, and a second cell pole 4b in the form of a negative pole, which is electrically and mechanically connected to a negative pole-side contact region 11 of the intercell connector 3b. In the present case, the battery cell 2 is configured as a round cell having a cylindrical cell housing 5.

In a feed-through opening in a housing cover 6 of the cell housing 5, a contact element 7 is arranged, which embodies the first cell pole 4a. The cell housing 5 itself, for example the housing cover 6, forms the second cell pole 4b. The first contact element 7 can be formed, for example, of aluminum. The cell housing 5 can be formed, for example, of steel. Between the contact element 7 and the cell housing 5, an unrepresented insulating element, for example a plastic sealing ring, is arranged which electrically separates the cell poles 4a, 4b. The intercell connectors 3a, 3b are metallic flat strip conductors 8, for example of aluminum which, in the present case, can be arranged on a carrier, for example on a plastic substrate. The intercell connectors 3a, 3b moreover comprise a fuse 9, which is embodied as a fusible interrupting region 12 of the flat strip conductor 8. In particular, the fusible interrupting region 12 is arranged contiguously to the respective positive pole-side contact region 10 of the intercell connectors 3a, 3b. The interrupting region 12 can comprise, for example, a cross-sectional taper. Upon the tripping of the fuse 9 in the event of a fault, the intercell connector 3a, 3b is interrupted in the interrupting region 12, for example wherein the cross-sectional taper is melted by a fault-related tripping current. A fault of this type can be, for example, an internal cell short-circuit within the battery cell 2, or “primary short-circuit”.

It is also possible, however, that a “secondary short-circuit” KS is present by way of a fault. This secondary short-circuit KS occurs, for example, in the event that the insulating material which electrically separates the cell poles 4a, 4b sustains damage, for example in response to heat, and the contact element 7 thus subsides in the direction of the housing cover 6. As a result, an unwanted electrical connection is formed between the cell poles 4a, 4b. A fault current thus flows via the intercell connectors 3a, 3b, which fault current lies below the tripping current, and can lie within the operating current range. As this fault current does not trip the fuse 9, further short-circuits, or “tertiary short-circuits” can be generated as a result.

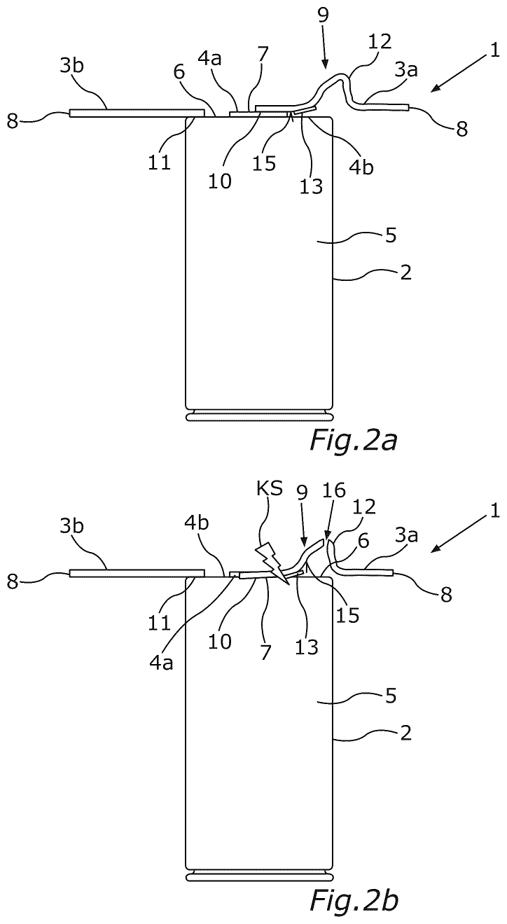

In order to ensure that the fuse 9 trips, even in the event of a fault current which lies below the tripping current, the assembly 1 comprises at least one conducting element 13 of an electrically conductive material, for example of steel. In the configuration of the assembly 1 according to FIG. 1A and FIG. 1B, the conducting element 13 is arranged on an upper side 14 of the intercell connector 3a, in a first contact region 10, and projects beyond one edge of the first cell pole 4a. In the configuration of the assembly 1 according to FIG. 2A and FIG. 2B, the conducting element 13 is arranged on an underside 15 of the intercell connector 3a. Excepting a fault, according to FIG. 1A and FIG. 2A, the conducting element 13 is arranged with a clearance to the housing cover 6, and thus establishes no electrical connection with the second cell pole 4b.

In the event of a fault, according to FIG. 1B and FIG. 2B, the first cell pole 4a and/or the intercell connector 3a commences to melt. As a result, the insulating element is damaged, and the first cell pole 4a can slip within the feed-through opening. As a result, the first cell pole 4a, and the intercell connector 3a which is bonded thereto, subsides. The conducting element 13 thus moves in the direction of the housing cover 6, until it engages with the housing cover 6. As a result, by means of the conducting element 13, an electrically conductive connection in the form of a short-circuit between the cell poles 4a, 4b is established such that, additionally to the mid-ohmic fault current, a short-circuit current flows via the intercell connector 3a, in response to which the fuse 9 is tripped, and an interruption 16 is executed. In the event of a fault, the cell poles 4a, 4b are thus actively short-circuited by the conducting element 13 such that, by way of a tripping current, an intentional short-circuit current flows via the intercell connector 3a.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An assembly for a traction battery of a motor vehicle, comprising:
a battery cell having a metallic cell housing, a first cell pole and a second cell pole which assumes a potential of the cell housing;
an intercell connector, which is electrically connected to the first cell pole to form a current path between the battery cell and at least one further battery cell of the traction battery, and which comprises a fuse for interrupting the current path in response to a flux of a tripping current; and
at least one electrically conductive conducting element, which is electrically and mechanically connected to the intercell connector and/or to the first cell pole, and which is designed, in an event of a fault current flux via the intercell connector which lies below the tripping current and which results in a melting and subsidence of the first cell pole and/or of the intercell connector in a direction of the cell housing, to contact-connect the cell housing and thus short-circuit the first and second cell poles, for providing the tripping current.

2. The assembly according to claim 1, wherein
the intercell connector comprises the fuse in the form of a fusible link, which is configured in the form of a cross-sectional taper in the intercell connector.

3. The assembly according to claim 1, wherein
the battery cell is a round cell with a cylindrical metallic cell housing,
the cell housing comprises a housing cover which embodies the second cell pole and has a feed-through opening, and
the first pole is embodied by a contact element which is led through the feed-through opening and which is electrically insulated from the housing cover via an insulating element.

4. The assembly according to claim 1, wherein
the at least one conductive conducting element comprises a material which differs from a material of the first cell pole and of the intercell connector, such that the electrical connection between the cell poles which is established via the at least one conductive conducting element in the event of a fault assumes a higher electrical conductivity than the electrical connection between the cell poles which is established in an event of a fault by the subsidence of the first cell pole.

5. The assembly according to claim 4, wherein
the material of the at least one conductive conducting element assumes a higher melting point than the material of the first cell pole and of the intercell connector.

6. The assembly according to claim 4, wherein
the material of the at least one conductive conducting element is at least one of: steel, copper, or tin, and
the material of the first cell pole and of the intercell connector is aluminum.

7. The assembly according to claim 1, wherein
the at least one conductive conducting element is configured with a plate-or strip-shaped design.

8. The assembly according to claim 1, wherein
the at least one conductive conducting element is fastened in an overlapping arrangement to the first cell pole on an upper side of the intercell connector, and projects beyond one edge of the first cell pole, so as to partially overlap with the housing cover and, excepting a fault, is arranged with a clearance to the housing cover.

9. The assembly according to claim 1, wherein
the at least one conductive conducting element is arranged on an underside of the intercell connector and, excepting a fault, is arranged with a clearance to the housing cover.

10. A traction battery for a motor vehicle comprising:
a plurality of assemblies according to claim 1, wherein
the battery cells form a cell assembly and the intercell connectors form a cell contact system for interconnection of the battery cells according to a predetermined interconnection layout.
